(19) United States
(12) Patent Application Publication
(10) Pub. No.: US 2003/0046688 A1
(43) Pub. Date: Mar. 6, 2003

(54) Video distributing method and system

(75) Inventor: Koichi Yoshido, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/228,998

(22) Filed: Aug. 28, 2002

(30) Foreign Application Priority Data
Aug. 30, 2001 (JP) 2001-260577

(51) Int. Cl. H04N 7/025; H04N 7/10; G06F 3/00; H04N 5/445; G06F 13/00

(52) U.S. Cl. 725/32; 725/40; 725/36

(57) ABSTRACT

According to video distributing method and system, in a video server connected to viewer terminals through a network 3, a list of plural supply service charges containing “free-charge” which are based on the CM amount to be inserted into one video content is stored in a content list 30 with CM-added charges in advance. When accepting a video information supply request from a viewer terminal, the information of the content list 30 with the CM-added charges is supplied to a Web page. When accepting an designation of a desired content and the CM amount thereof from a terminal, a video signal composite portion 27 receives this designation, and only the CM amount based on the designation is inserted in the video content stored in the content portion 24 corresponding to the indicated content. The video content containing the CM is distributed to the requesting terminal.

### BACKGROUND OF THE INVENTION

1. Field of the Invention

The present invention relates to a method and system for distributing video information to viewers through a network and particularly, to a video distributing method and video distributing system that can specify minutely (in detail) commercial message (CM) insertion conditions for video information to be distributed in association with service charges, whereby desired video contents can be supplied to users at low price and also the sponsors can execute their effective advertisement (promos) which are focused on special targets.

2. Description of the Related Art

A relatively low speed communication line using a general telephone subscriber line or ISDN has been hitherto used as the internet line used by general Internet subscribers. Accordingly, much transmission time is needed to distribute a movie having a large data amount or other video information through the Internet, and thus it has been unrealistic. However, high-speed communication lines using ADSL or optical fibers have been recently available at relatively low cost. In connection with this, transmission of video information which has been hitherto unrealistic can be easily performed at present. In such a situation, it has been increasingly required to distribute video contents through the Internet to users. However, contents such as movies, promotion videos are supplied at high price, and thus it is not economically easy for users to request distribution of a large number of their favorite contents.

Therefore, if users can be distributed with their favorite contents at as low price as possible although it is somewhat inconvenient, this is very pleasant for general Internet subscribers. Accordingly, it has been proposed that sponsor's CM (Commercial Message) is inserted in contents.

Further, a charging device and a communication system disclosed in Japanese Laid-open Patent Publication No. Hei-9-212252 are known for such type of video distribution as described above. One purpose of this technique resides in that a sponsor (a sponsor) supplies CM and bears the charge of the supply of CM to thereby make appropriate the charge to be imposed on viewers as users of a video distribution service.

According to the communication system described above, information suppliers 104 and sponsors 105 are connected to network 103 to which viewer's terminals 101 and transmission path suppliers 102 are connected, and information are mutually exchanged to one another through the network 103 as shown in FIG. 1.

Further, the supply information 110 is appended with information inherent data PID inherent to the supply information, supplier setting data TID set by a supplier and CM-associated data CID on CM as shown in FIG. 2.

In charging device 120 of a viewer terminal, the appended data of the supply information 110 received by supply information portion 121 is collated with charge information stored in charge settling portion 123 by data check portion 122 to judge whether the supply information received is available or not. Here, if the charge information in the charge settling portion 123 sufficiently satisfies payment of the charge information of the appended data, the supply information would be available. In this case, the supply information 110 received is processed by information processor 125 and a viewer can watch/listen to the supply information on display portion 124.

That is, the charge which a viewer bears in connection with the amount of CM can be set by designating in the CM-associated data CID a burden charge for CM viewing which a sponsor can set. As a result, the viewer can select one of various conditions in the range from the highest burden charge condition where the viewer can watch/listen to the highest-price supply information (video information or the like) having no CM to the lowest burden charge condition where the viewer can watch/listen to the lowest-price supply information (video information or the like) having many CMs. Further, insertion of CM may be made through a sponsor or through an information supplier.

Further, there is known a communication system and a terminal device disclosed in Japanese Laid-open Patent Publication No. Hei-9-18853, for example. That is, it has been pursued in the multimedia network that proper charging is carried out on respective persons who bear the charges for CMs supplied from sponsors.

As shown in FIG. 3, according to this system, each viewer terminal 210 using video information, each information supplier terminal 220 for supplying video information and each sponsor terminal 230 owned by each sponsor are connected to network 240. The viewer terminal 210 has a CM selecting portion, and it is selected by a viewer whether CM is accepted or not (i.e., the viewer selects acceptance or non-acceptance of CM). The information supplier terminal 220 receives a notification on “acceptance or non-acceptance” of CM transmitted from the viewer terminal 210 through the network 240.

Accordingly, when CM is accepted, CM insertion portion 223 inserts CM picked up from CM data base 222 into video information picked up from video library 221, and transmits it to the viewer terminal 210 through the network 240. Charging portion 224 transmits charge information to sponsor terminal 230. Further, when the viewer terminal 210 accepts no CM, only video contents are transmitted to the viewer terminal 210, and the sponsor is not charged.

As a result, when a viewer enjoys video information having CM inserted therein, the amount of money corresponding to insertion of CM is charged to the sponsor of the CM. Therefore, the viewer can enjoy the video information at no charge or at lower charge than when he/she enjoys video information having no advertisement (no CM).

However, the conventional communication system on the video distribution described above has a disadvantage that it lacks versatility when at least a viewer using this system selects a video work. This is because the insertion amount of CM in information or video information to be supplied is beforehand notified as the CM-associated data (in the former case, that is, in a charging device and a communication system disclosed in Japanese Laid-open Patent Publication No. Hei-9-212252) and as the data on “acceptance or non-acceptance” of CM data base (in the latter case, that is, in a communication system and a terminal device disclosed in Japanese Laid-open Patent Publication No. Hei-9-18853), and these data are fixedly set in respective pieces of video information in advance.

As a result, the conventional communication system cannot support such a situation that with respect to the same video information, a first viewer wishes to enjoy it at free charge in spite of a large amount of CM, a second viewer wishes to enjoy it even at high charge because it has no CM and also a third viewer wishes to enjoy it under an intermediate condition between the first and second viewers. Further, a sponsor (advertiser) has been hitherto able to freely select contents in which CM is inserted, however, it has been difficult to minutely set the use charge corresponding to the CM amount for contents.

### SUMMARY OF THE INVENTION

The present invention has been implemented in view of the foregoing situation, and has an object to provide video distributing method and system that enable viewers and sponsors to specify delicately CM insertion conditions of video information to be distributed in association with supply service charges of the video information.

According to a first aspect of the present invention, there is provided a method for distributing video information to a viewer through a network, comprising: a step of presetting plural insertion conditions for inserting a commercial message of a sponsor in video information and the supply service charges corresponding to the respective plural insertion conditions, and storing the plural insertion conditions and the supply service charges in a video server; a step of presenting the plural insertion conditions and supply service charges from the video server to a network terminal of the viewer when the video server receives a video information supply request from the network terminal; a step of accepting designation of one of the insertion conditions and one of the supply service charges from the network terminal; and a step of supplying the video information based on the designation from the video server to the network terminal.

Further, according to a second aspect of the present invention, there is a method for distributing video information to a viewer through a network, comprising: a step of presetting plural insertion conditions for inserting a commercial message of a sponsor in video information and the supply service charges corresponding to the respective plural insertion conditions, and storing the plural insertion conditions and the supply service charges in a video server; a step of presenting the plural insertion conditions from the video server to a network terminal of the viewer when the video server receives a video information supply request from the network terminal, and accepting designation of one of the insertion conditions from the network terminal; a step of presenting the supply service charges corresponding to the designation from the video server to the network terminal, and accepting a viewer's acknowledgement from the network terminal; and a step of supplying the video information based on the designation from the video server to the network terminal.

Further, according to a third aspect of the present invention, there is a video distributing system in which a video server distributes video information to a viewer terminal connected to the video server through a network by using a broadband modem, the video server comprising: a contents list for storing, as image data, plural insertion conditions for inserting a commercial message of a sponsor and the supply service charges corresponding to the plural insertion conditions every video contents; a video contents portion provided every video contents transmitted to the viewer terminal, the video contents portion storing video contents and commercial message to be inserted into the video contents, and when the video contents portion accepts an designation of a commercial message insertion condition from the viewer terminal, the video contents portion inserting the commercial message into the video contents to be transmitted thereby generating video information; and a contents selecting portion for picking up the image data stored in the contents list and transmitting the image data to the viewer terminal when accepting a video information distributing request from the viewer terminal, and instructing the video contents portion to generate video information and also instructing transmission of the video information thus generated when receiving the video content and the commercial message insertion condition thereof from the viewer terminal.

Still further, according to a fourth aspect of the present invention, there is a video distributing system in which a video server distributes video information to a viewer terminal connected to the video server through a network by using a broadband modem, the video server comprising: a contents list for storing, as image data, plural video contents, plural insertion conditions for a commercial message to be inserted in the video contents and the supply service charges corresponding to the insertion conditions; a video contents storage portion for storing the video contents transmitted to the viewer terminals; a CM storage portion for storing plural commercial messages to be inserted into the video contents which will be transmitted; a contents selecting portion for picking up the image data stored in the contents list and transmitting the image data to the viewer terminal when receiving a video information distributing request from the viewer terminal, so that the contents and the commercial message insertion condition thereof are outputted; a contents designating portion for designating the contents received from the contents selecting portion to the video contents storage portion to pick up the contents, and picking up the commercial message based on the commercial message insertion condition received to transmit the commercial message; and a video signal composite portion for inserting the commercial message selected from the CM storage portion into the video contents received from the video contents storage portion according to the commercial message insertion condition which is indicated by the contents designating portion and transmitted, and generating video information.

### BRIEF DESCRIPTION OF THE DRAWINGS

FIG. 1 is a block diagram showing an example of a conventional communication system;

FIG. 2 is a block diagram showing an example of a viewer terminal;

FIG. 3 is a block diagram showing another example of a conventional communication system;

FIG. 4 is a diagram showing a system of an embodiment of the present invention;

FIG. 5 is a diagram showing an embodiment of a video stream according to the present invention;

FIG. 6 is a functional block diagram showing an embodiment of a video server of FIG. 4;

FIG. 7 is a diagram showing an embodiment of a content list of contents with CM-added charges in FIG. 4;

FIG. 8 is a flowchart showing an embodiment of the main operation procedure of distributing contents in FIG. 4;

FIG. 9 is a diagram showing an embodiment of a content list of contents with CM-added charges which is different from that of FIG. 7;

FIG. 10 is a diagram showing embodiment which can be added to the content list with the CM-added charges in FIG. 4; and

FIG. 11 is a functional block diagram showing an embodiment of a video server different from that of FIG. 7.

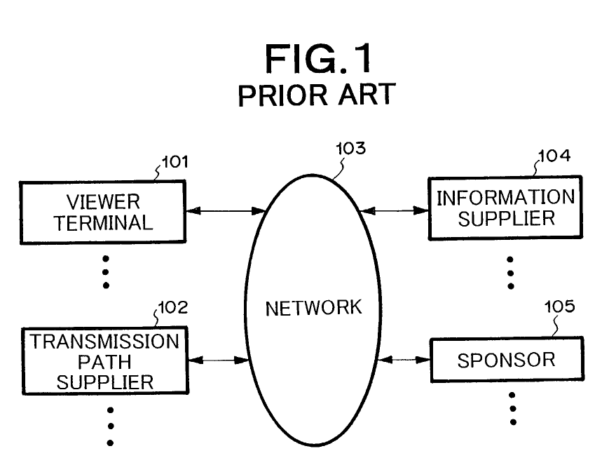

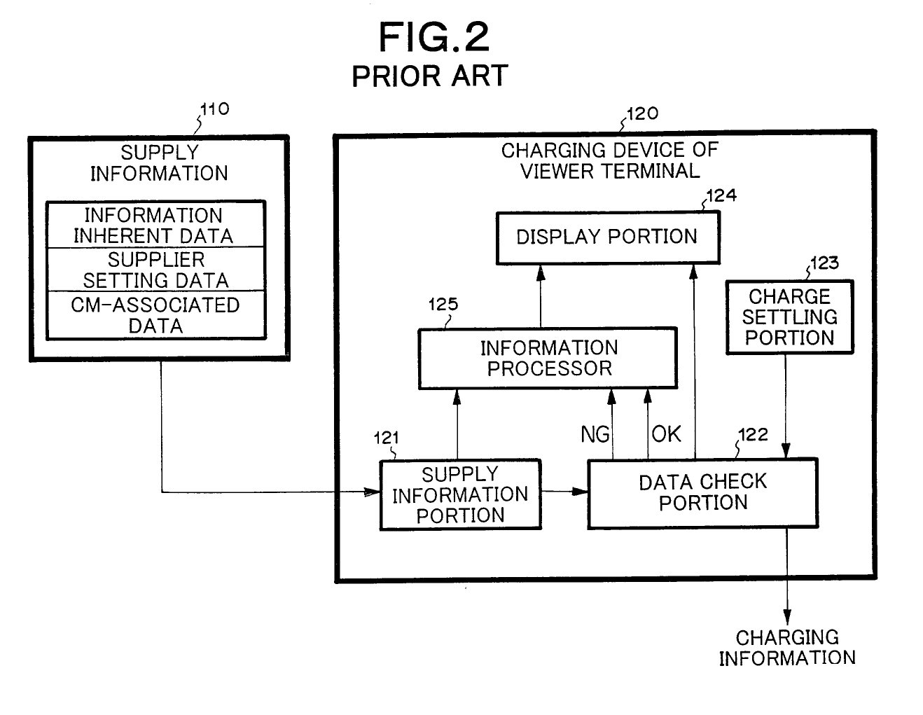

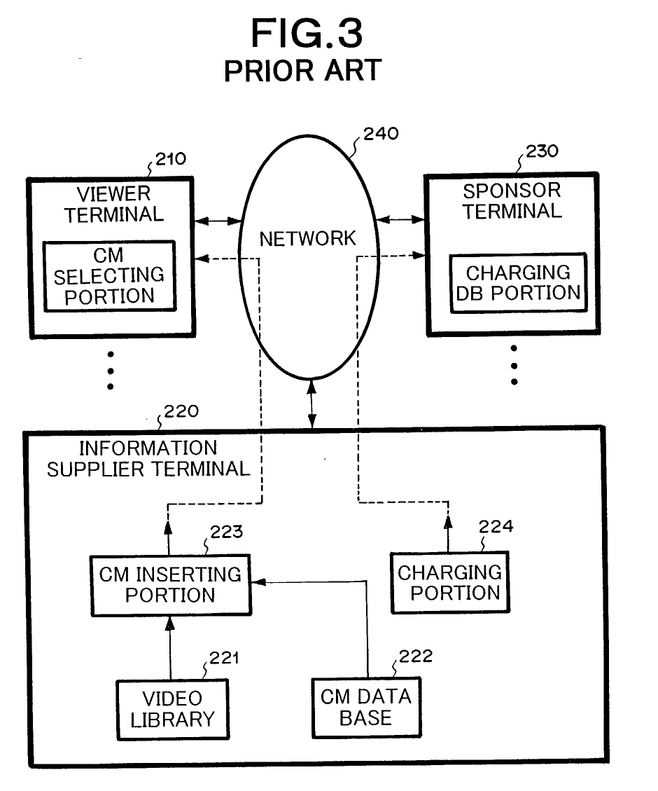

### DETAILED DESCRIPTION OF THE PREFERRED EMBODIMENTS

Preferred embodiments according to the present invention will be described hereunder with reference to the accompanying drawings.

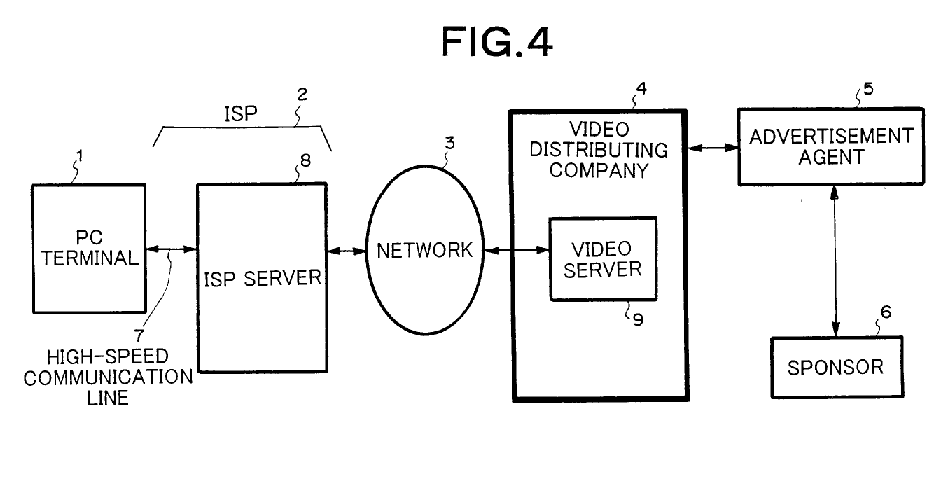

FIG. 4 is a functional block diagram showing an embodiment of the present invention.

The video distributing system shown in FIG. 4 comprises PC (Personal Computer) terminal 1, ISP (Internet Service Provider) 2, network 3, video distributing company 4, advertisement agent 5 and sponsor 6. ISP 2 has high-speed line 7 and ISP server 8, and the video distributing company 4 has video server 9. That is, the PC terminal 1 is connected to the ISP server 8 through the high-speed communication line 7 by ISP 2 contracted in advance, so that it can watch Web pages on the network 3 through the ISP server 8 by using URL. Accordingly, the PC terminal 1 possessed by a viewer can access, as a viewer terminal, the video server 9 of the video distributing company 4 by using URL. The network 3 supports the Internet set up at the worldwide scale. ADSL (Asymmetric Digital Subscriber Line) or an optical fiber cable with which moving pictures can be transmitted at high speed is used as the high-speed communication line 7. As described above, the video distributing system according to this embodiment has a general construction based on the Internet.

It is assumed that the video distributing company 4 receives a commercial message (hereinafter referred to as “CM”) which is requested by a sponsor 6 and transmitted from an advertising agent 5 and undertakes distribution of the CM. Further, it is also assumed that the video distributing company 4 creates a Web page on the network 3 by using the video server 9 and renews the Web page as occasion demands to make a video contents list open to viewers upon accesses from the viewers and supply indicated contents to the viewers. Further, it is assumed that upon undertaking a request from the sponsor 6, the advertising agent 5 creates CM and requests an advertisement of the CM concerned to the video distributing company 4.

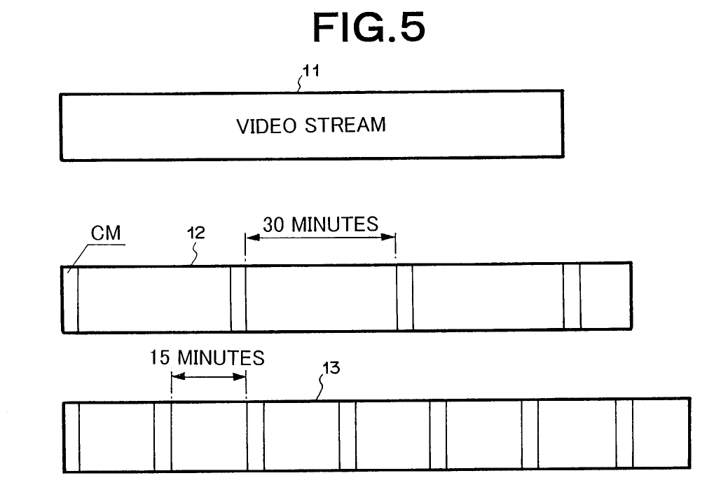

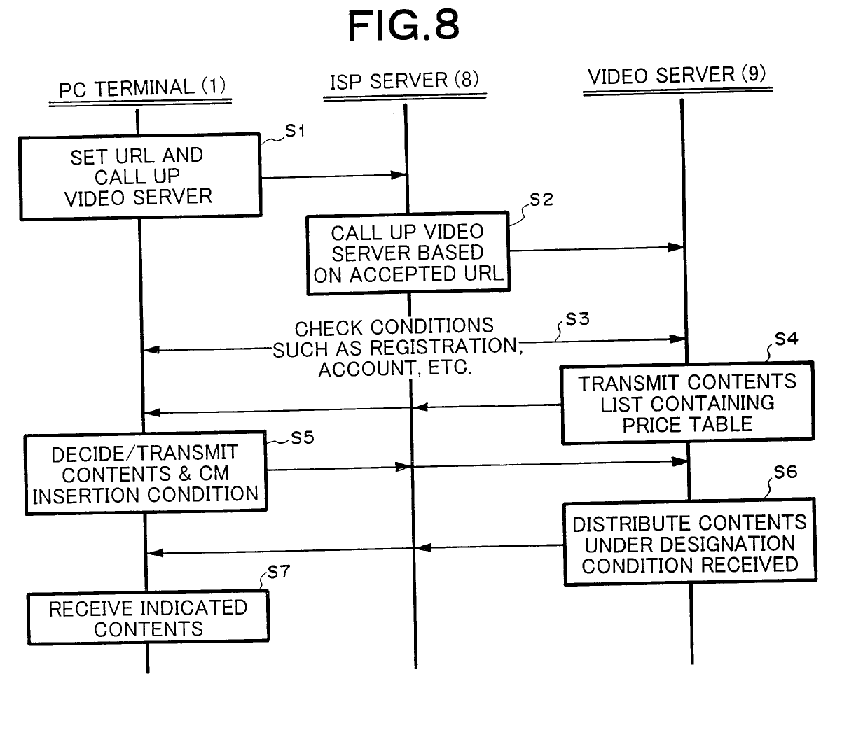

In the above-described construction, the video information supply portion having various kinds of CM insertion conditions will be described in detail with reference to FIGS. 5 to 8.

First, a format of video information will be described with reference to FIG. 5.

FIG. 5 shows video streams 11, 12 and 13 corresponding to three kinds of video information, respectively.

No CM is inserted in the video stream 11. Accordingly, the full amount for this supply service is charged to a viewer using this service. Therefore, the viewer must pay a large amount of money for the service, however, he/she can enjoy the video contents without being disturbed by CM.

The video stream 12 contains CM which is inserted every 30 minutes, totally four times. Further, the video stream 13 contains CM which is inserted every 15 minutes, totally seven times. When the money to be charged to the sponsor for CM of one time is equal to 200 yen, the money to be charged to the sponsor for each of the video streams 12, 13 is equal to 800 yen, 1,400 yen, respectively.

For example, when the supply service charge of the video contents is equal to 1,400 yen, the money to be charged to each viewer is equal to the difference between the supply service charge and the burden charge of the sponsor, that is, 1,400 yen, 600 yen and no charge for the video streams 11, 12 and 13, respectively.

In FIG. 5, CM is inserted at the same time interval. However, actually, CM is inserted into scene-switched places of moving pictures. When CMs to be inserted are different in required time, the sponsor may be charged not on the basis of the replay frequency of the CMs, but on the basis of the total time of the CMs as the amount of CM. When a combination of the above charging manners is allowed, the burden charge of each user can be more minutely settled.

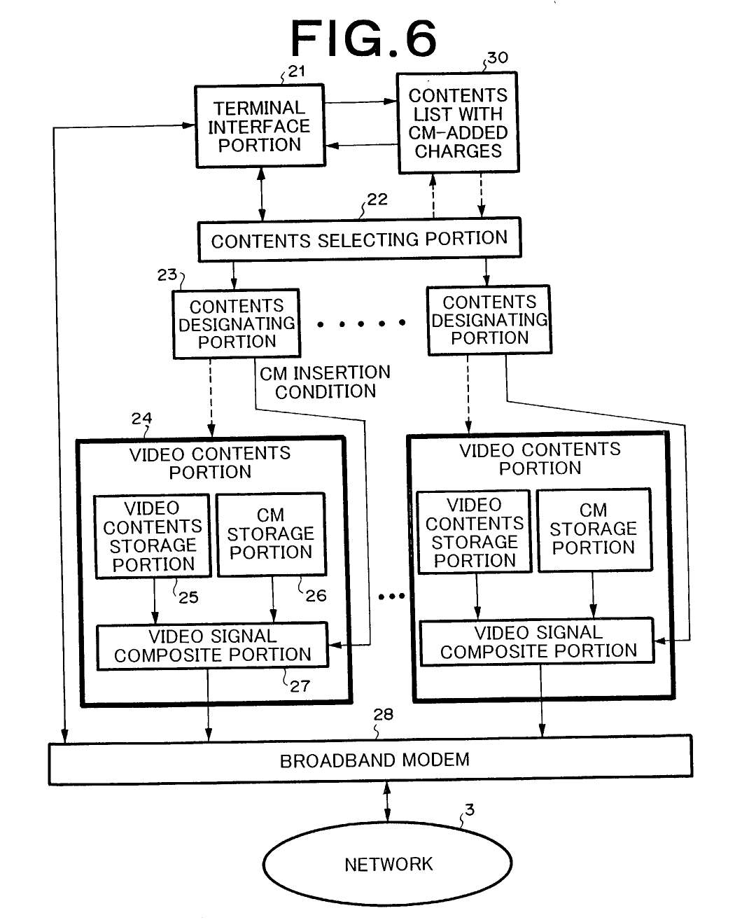

Next, an embodiment of the construction of the video server 9 shown in FIG. 4 will be described with reference to the video information of FIG. 5 together with FIGS. 4 and 6.

As shown in FIG. 6, the video server 9 shown in FIG. 4 comprises terminal interface portion 21, contents selecting portion 22, contents designating portions 23 and video contents portions 24 which correspond to plural video contents respectively, a broadband modem 28 connected to the network 3 and contents list 30 with CM-added charges. Each video contents portion 24 contains video contents storage portion 25, CM storage portion 26 and video signal composite portion 27.

Each constituent element of FIG. 6 will be described with reference to FIGS. 4 and 6.

The terminal interface portion 21 is connected to the network 3 through the broadband modem 28, and has Web pages for the Internet. When accessed on the basis of URL for calling up a Web page by a PC terminal 1 through the network 3, the terminal interface portion 21 transmits the data of the Web page concerned to the PC terminal 1. Further, when a link designation is made on the screen, the terminal interface portion 21 transmits this designation to a link destination.

Normally, the users of this system are limited to registered members for pay. Accordingly, only when a registered member logs in on the basis of a member ID (identifier) and a password which are registered in advance in the video distributing company 4, the registered member can call up a link destination from the terminal interface portion 21 on a homepage.

The contents selecting portion 22 accepts a contents designation containing a CM insertion condition which is selected from the contents list 30 appended with the CM-added charges and transmitted by the PC terminal 1. Subsequently, the contents designating portion 23 connected to the video contents portion 24 having the video contents indicated is selected by the contents selecting portion 22, and this designation is notified to the contents designating portion 23 together with the address of the PC terminal 1 as the designation request source.

The contents designating portion 23 receives the CM insertion condition when drive by the contents selecting portion 22, and transmits the CM insertion condition concerned to the video signal composite portion 27 of the video contents portion 24 together with the address of the PC terminal 1 as the request source.

In the video contents portion 24, the video contents storage portion 25 accumulates and holds video contents (contents of a video work). The CM storage portion 26 beforehand accumulates and holds CM to be inserted into the contents stored in the video contents storage portion 25. The contents of this CM can be changed at any time by change of the sponsor or in compliance with sponsor's wishes. Even when plural CMs are inserted at a time, the supply service charges can be easily set if the contents of each time are the same.

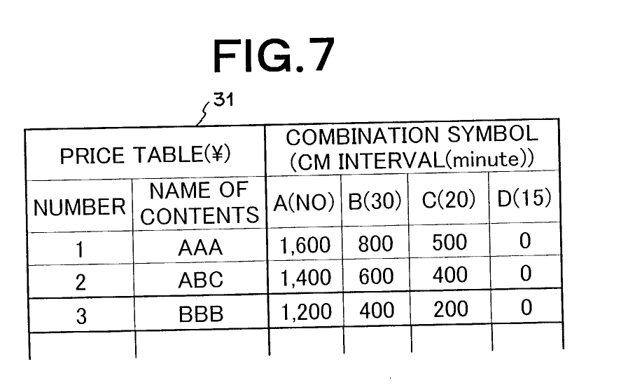

The video signal composite portion 27 inserts the CM of the CM storage portion 26 into the video contents of the video contents storage portion 25 according to the CM insertion condition received from the contents designating portion 23, and outputs it to the broadband modem 28 while the distribution destination is set to the PC terminal 1 as the request source. With respect to the CM insertion condition, the insertion interval of the same CM may be indicated to 20 minutes as shown in FIG. 7, for example. Further, at least the video contents are subjected to data compression and enciphering, and thus even when a person other than registered members can down-load contents, he/she cannot decode and watch/listen to the contents.

The broadband modem 28 is equipped for transmission of moving pictures and further for many viewer members.

In the embodiment, the contents list 30 with the CM-added charges (for example, see FIG. 7) containing the CM insertion conditions described with reference to FIG. 5 is prepared on a Web page in advance. Further, a viewer using this service can watch this Web page to indicate contents (contents of a video work) appended with one CM insertion condition. Accordingly, in response to this designation from the viewer, the contents selecting portion 22 indicates the video contents portion 24 linked to this designation and inputs the CM insertion condition into the video signal composite portion 27, so that the video information of the contents indicated by the viewer is generated and transmitted to the viewer.

Next, a price table 31 as an example of the content list 30 with the CM-added charges of FIG. 6 will be described with reference to FIGS. 5 and 7.

FIG. 7 shows an example of a part of the contents list displayed on the screen of a viewer terminal when there is a supply request of video contents from a viewer. For example, with respect to a contents name AAA numbered “1”, 1600 yen is charged in case of no CM (symbol A), 800 yen is charged in case of CM interval of 30 minutes (symbol B), 500 yen is charged in case of CM interval of 20 minutes (symbol C) and no money is charged (free charge) in case of CM interval of 15 minutes (symbol D).

As not shown, an designation is guided to be input in the form of a combination of symbols every video content. Accordingly, when contents AAA having no CM is indicated, a number symbol “1A” is input, and 1600 yen is charged to a viewer. When the viewer desires no-charge, a number symbol “1D” is input.

Next, the main operation procedure until the PC terminal 1 requests contents and then receives it will be described with reference FIGS. 4 to 8.

As described above, a viewer who wishes distribution of video contents has the member ID and the password which are registered in the video distributing company 4 of this system in advance.

The viewer sets prescribed URL from the PC terminal 1 and calls up the video server 9 of the video distributing company 4 through the Internet (step S1). This call-up is connected through the high-speed communication line 7 to the ISP server 8 of ISP (Internet Service Provider) 2 with which the viewer makes a contract. The ISP server 8 calls up the video server 9 of the video distributing company 4 through the network 3 on the basis of URL received (step S2).

In the video server 9, the terminal interface portion 21 of FIG. 6 accepts this call-up, and it first transmits a homepage and receives the member ID and the password of the viewer to check coincidence of the member ID and the password (step S3). After this check, the terminal interface portion 21 picks up the price table 31 of FIG. 7 from the contents list 30 with the CM-added charges, and transmits the price table 31 to the PC terminal 1 (step S4).

When a combination symbol “2C” of the price table 31 of FIG. 7 is indicated at the PC terminal 1 by the viewer, settle information of the combination symbol “2C” is transmitted from the PC terminal 1 to the video server 9 (step S5). In the video server 9, the contents selecting portion 22 accepts the settle information. The combination symbol “2C” means a request for supplying a content ABC which contains CM inserted every 20 minutes and charges 400 yen.

Accordingly, the contents selecting portion 22 receiving the combination symbol “2C” selects the contents designating portion 23 connected to the video contents portion 24 in which the contents ABC are stored, and notifies “20-minute interval” of the CM insertion condition. The contents designating portion 23 notifies it to the video signal composite portion 27. The video signal composite portion 27 receiving this notification picks up the video contents from the video contents storage portion 25, and inserts CM stored in the CM storage portion 26 into a predetermined place of the pickup video contents. The composite video contents containing CM thus prepared is enciphered to create a video signal. The video signal thus created is distributed from the broadband modem 28 through the network 3 to the PC terminal 1 as the request source (step S6).

In the PC terminal 1, the contents indicated by the video signal distributed is received (step S7), and it is deciphered by a deciphering key received when member registration is made, whereby the viewer can watch pictures displayed on the screen and listen to the sounds.

In the foregoing description with reference to FIG. 7, the charges are set on the basis of the CM insertion interval. However, the charges may be set on the basis of other insertion conditions. For example, the contents list may be created on the basis of one or a combination of the CM insertion frequency and the total insertion time for the time of one CM insertion and the time of contents. Accordingly, the CM insertion condition may be selected from at least one of the insertion interval of CM, the insertion frequency of CM and the total insertion time of CM.

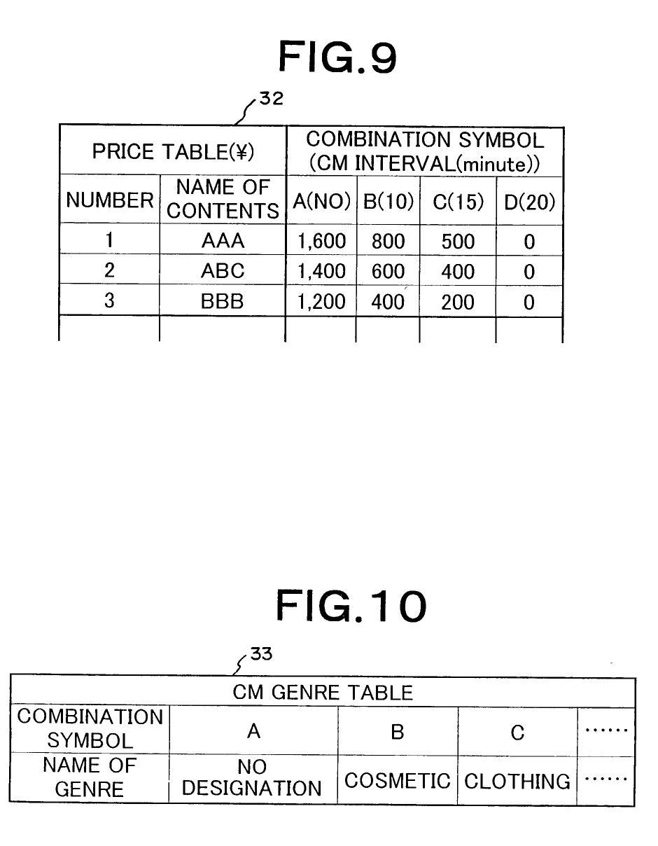

FIG. 9 shows price table 32 with respect to CM insertion total time. The price content is the same as shown in FIG. 7. However, the insertion timing of CM may be freely set to story-breakable points by the video distributing company. Therefore, this setting has an advantage that the CM insertion condition is convenient for viewing and the video distributing company can more easily set the CM insertion condition.

In the above-described embodiment, CMs to be inserted in connection with the video contents are stored. Therefore, sponsors have an advantage that they can select contents into which CMs are inserted. As a result, the sponsors can implement effective promos focused on the viewer layer which is different in accordance with the content. Further, they can implement effective promos concentrated on highly popular contents.

Further, the above-described embodiment may be modified so that if viewers are intercepted from viewing stories, they may select CM genre.

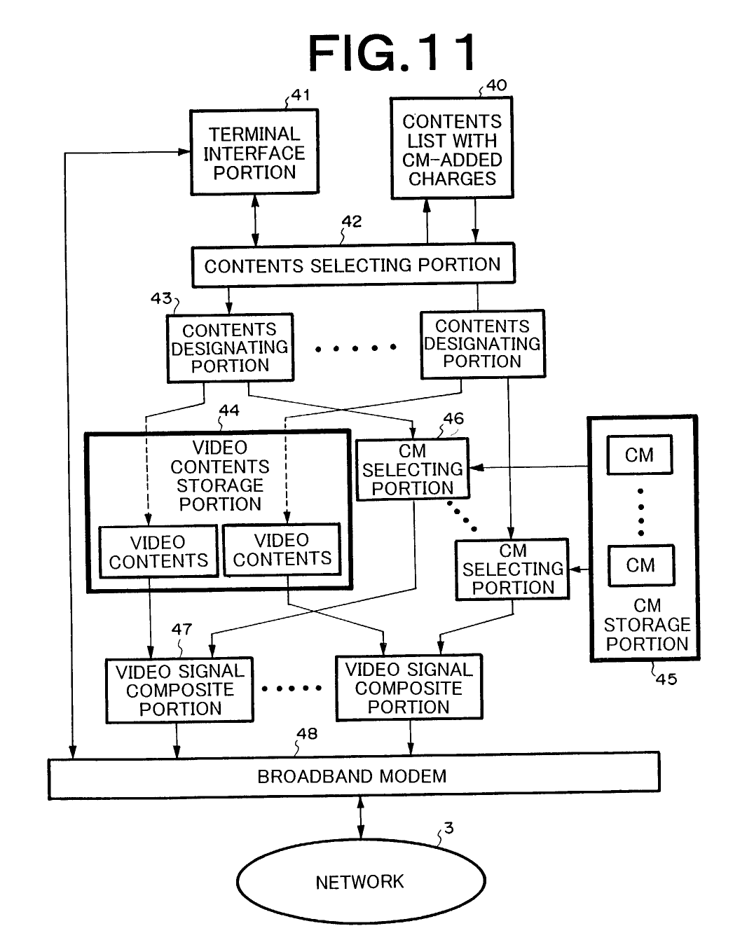

FIG. 10 shows an example of a CM genre table 33 achieved by listing genre names of CM together with combination symbols in addition to the price table.

In the case where the CM genre table 33 as described above is provided, there is no relationship when commercial messages belonging to the relevant genres are inserted in the same content. In the case of commercial messages irrelevant to the content, the sponsors can select commercial messages belonging to a genre favorite to viewers over broad genres. For example, when cosmetic (symbol B) is selected, a combination symbol “1AB” may be indicated in combination with the table of FIG. 9.

By setting various insertion conditions in the content list with the CM-added charges as described above, the supply of video contents which is convenient for the viewers and the sponsors can be performed.

Next, another embodiment of the video server 9 of FIG. 4 will be described with reference to the tables shown in FIGS. 9 and 10 and FIG. 4.

A video server shown in FIG. 11 comprises contents list 40 with CM-added charges, terminal interface portion 41, contents selecting portion 42, plural contents designating portions 43 corresponding to plural video contents, video contents storage portion 44 for storing the plural video contents in advance, CM storage portion 45 for storing plural CMs in advance, CM selecting portions 46 and video signal composite portions 47 which correspond to the contents designating portions 43, and broadband modem 48 connected to the network 3.

The respective constituent elements of FIG. 11 will be described with reference to FIGS. 4 and 7.

The content list 40 with the CM-added charges is beforehand stored as data which are used to guide selection and designation of the price table 32 of FIG. 9 and the CM genre table 33 of FIG. 10 and also can be displayed on the Web page on the basis of a request from the PC terminal 1 of a registered member.

The terminal interface portion 41 has the same function as the terminal interface portion 21 shown in FIG. 6, and thus the description thereof is omitted.

The contents selecting portion 42 receives an designation of contents appended with a CM insertion condition which is selected from the contents list 40 with the CM-added charges received by the PC terminal 1. Subsequently, in the video contents storage portion 44, the contents designating portion 43 connected to the video contents indicated is selected by the contents selecting portion 42, and the designation concerned is notified to the contents designating portion 43 together with the address of the PC terminal 1 as the designation request source.

The contents designating portion 43 receives the CM insertion condition when it is driven by the contents selecting portion 42, and transmits the CM insertion condition thus received to the CM selecting portion 46 together with the address of the PC terminal 1 as the request source.

In the video contents storage portion 44, video contents (contents of a video work) corresponds to the contents designating portion 43 and the video signal composite portion 47, and the video contents are picked up from the video signal composite portion 47.

The CM storage portion 45 beforehand stores various CMs to be inserted in the respective video contents stored in the video contents storage portion 44. The contents of the CMs can be changed when a sponsor is changed or in compliance with sponsor's wish as occasion demands.

The CM selecting portion 46 picks up the indicated CM from the CM storage portion 45 on the basis of the designation of the CM insertion condition received from the contents designating portion 43, and transmits it to the video signal composite portion 47. This CM is not picked up when the insertion thereof is not indicated, and it may be picked up at plural times in accordance with the type of the designation.

The video signal composite portion 47 picks up the video contents from the video contents storage portion 44 according to the CM insertion condition received from the contents designating portion 43 through the CM selecting portion 46, inserts CM received from the CM selecting portion 46 into an indicated place of the video contents thus picked up, and then outputs it to the broadband modem 48 while the distribution destination is set to the PC terminal 1 as the request source. For example when the CM insertion condition is a combination symbol “2CC” shown in FIGS. 9 and 10, CM of clothing is inserted for totally 15 minutes. Further, CMs of plural genres may be indicated to select “charge-free”.

In the foregoing description, the price table is shown and described as the contents list with the CM-added charges. However, the contents list may be modified so that a viewer can indicate the amount of CM to be inserted into a video content and requests the charge of the video contents to the video distributing company as the supplier.

For example, if the function is added in FIG. 11, when an designation of “advertisement amount of 15 minutes” is received from a PC terminal, the contents selecting portion 42 picks up data from the contents list 40 with the CM-added charges and a charge estimation is displayed on the Web screen. A viewer who accepts this estimation result transmits “acknowledgement” information from the PC terminal to receive distribution service.

In the foregoing description, the video distributing company has a video server on the assumption that division of labor is expected to be best from the business style, however, an advertisement agent or sponsor may create commercial messages, prepare video contents and supply the distribution service of the video contents.

In the foregoing description, the functional blocks and the steps shown in the figures are referred to. However, alteration of sharing in work due to separation or integration of functions, exchange of the previous and subsequent steps on the time axis, etc. be freely performed, and the present invention is not limited to the above embodiments. Further, the present invention may be applied to general portable telephones

As described above, according to the present invention, the following effects can be achieved.

A first effect resides in that the present invention can support such a situation that a viewer wishes to enjoy a piece of video information distributed at free charge in spite of many CMs inserted in the video information, or enjoy it even at high charge because it has no CM, or enjoy it under an intermediate condition. This broadens the selectable range of charges by viewers. This is because when a viewer requests distribution, he/she can compare the CM amount such as the frequency, time, etc. of CM with the supply service charge thereof to select and indicate a proper condition.

A second effect resides in that when a sponsor selects contents and inserts CM into the contents, the sponsor can minutely set the use charges for contents. This is because a diversified supply service charge system from “high price” to “charge-free” can be applied to viewers for contents in accordance with the amount of CM. As a result, the use frequency of video contents which are available at low price because they contain CM is expected to increase.

What is claimed is:

1. A method for distributing video information to a viewer through a network, comprising:
a step of presetting plural insertion conditions for inserting a commercial message of a sponsor in video information and the supply service charges corresponding to the respective plural insertion conditions, and storing the plural insertion conditions and the supply service charges in a video server;
a step of presenting the plural insertion conditions and supply service charges from said video server to a network terminal of the viewer when said video server receives a video information supply request from said network terminal;
a step of accepting designation of one of the insertion conditions and one of the supply service charges from said network terminal; and
a step of supplying the video information based on the designation from the video server to said network terminal.

2. The method as claimed in claim 1, wherein video information and the commercial message corresponding to the video information are stored in said video server, and when said video server accepts the designation in said accepting step, said video server inserts and combines the commercial message with the video information under the designation and then supplies it to said network terminal in said supplying step.

3. The video distributing method as claimed in claim 1, wherein the insertion conditions are selected from at least one of the insertion interval, insertion frequency and total insertion time of the commercial message.

4. The video distributing method as claimed in claim 1, wherein the insertion conditions contain a condition under which supply service charge is made free.

5. The video distributing method as claimed in claim 1, wherein the designation contains the type of genre of the commercial message.

6. A method for distributing video information to a viewer through a network, comprising:
a step of presetting plural insertion conditions for inserting a commercial message of a sponsor in video information and the supply service charges corresponding to the respective plural insertion conditions, and storing the plural insertion conditions and the supply service charges in a video server;
a step of presenting the plural insertion conditions from said video server to a network terminal of the viewer when said video server receives a video information supply request from said network terminal, and accepting designation of one of the insertion conditions from said network terminal;
a step of presenting the supply service charges corresponding to the designation from said video server to said network terminal, and accepting a viewer's acknowledgement from said network terminal; and
a step of supplying the video information based on the designation from the video server to said network terminal.

7. A video distributing system in which a video server distributes video information to a viewer terminal connected to said video server through a network by using a broadband modem, said video server comprising:
a contents list for storing, as image data, plural insertion conditions for inserting a commercial message of a sponsor and the supply service charges corresponding to the plural insertion conditions every video contents;
a video contents portion provided every video contents transmitted to said viewer terminal, said video contents portion storing video contents and commercial message to be inserted into the video contents, and when said video contents portion accepts an designation of a commercial message insertion condition from said viewer terminal, said video contents portion inserting the commercial message into the video contents to be transmitted thereby generating video information; and
a contents selecting portion for picking up the image data stored in said contents list and transmitting the image data to said viewer terminal when accepting a video information distributing request from said viewer terminal, and instructing said video contents portion to generate video information and also instructing transmission of the video information thus generated when receiving the video content and the commercial message insertion condition thereof from said viewer terminal.

8. A video distributing system in which a video server distributes video information to a viewer terminal connected to said video server through a network by using a broadband modem, said video server comprising:
a contents list for storing, as image data, plural video contents, plural insertion conditions for a commercial message to be inserted in the video contents and the supply service charges corresponding to the insertion conditions;
a video contents storage portion for storing the video contents transmitted to said viewer terminals;
a CM storage portion for storing plural commercial messages to be inserted into the video contents which will be transmitted;
a contents selecting portion for picking up the image data stored in said contents list and transmitting the image data to said viewer terminal when receiving a video information distributing request from said viewer terminal, so that the contents and the commercial message insertion condition thereof are outputted;
a contents designating portion for designating the contents received from said contents selecting portion to said video contents storage portion to pick up the contents, and picking up the commercial message based on the commercial message insertion condition received to transmit the commercial message; and
a video signal composite portion for inserting the commercial message selected from said CM storage portion into the video contents received from said video contents storage portion according to the commercial message insertion condition which is indicated by said contents designating portion and transmitted, and generating video information.

9. The video distributing system as claimed in claim 8, wherein said contents list further contains a genre type list of commercial message, and said contents designating portion picks up the commercial message based on a genre designation received from said viewer terminal from said CM storage portion.
